(19) United States
(12) Patent Application Publication
(10) Pub. No.: US 2021/0007268 A1
(43) Pub. Date: Jan. 14, 2021

(54) SOIL-OPENER FOR INTRODUCING A PRODUCT INTO SOIL

(71) Applicant: LOW DISTURBANCE B.V., Wageningen (NL)

(72) Inventor: Thierry STOKKERMANS, Wageningen (NL)

(21) Appl. No.: 16/956,292

(22) PCT Filed: Dec. 14, 2018
(86) PCT No.: PCT/NL2018/050843

§ 371 Date: Jun. 19, 2020

(30) Foreign Application Priority Data
Dec. 20, 2017 (NL) 2020139

(51) Int. Cl. A01C 5/06; A01C 7/20

(52) U.S. Cl. CPC A01C 5/062; A01C 7/06; A01C 7/206

(57) ABSTRACT

The invention provides a soil-opener (3) for in operation providing a functional horizontal cut at a depth from a soil surface in a functionally vertical cut into soil for providing a soil flap (16) for introducing a product into said soil, said soil-opener (3) comprising: a blade (10) having a front cutting edge (17) for cutting said functionally horizontal cut, a rear end (18), a blade width, and arranged for cutting soil functionally cross with respect to a said functionally vertical cut; a channel forming part (12) coupled to said blade (10), ending at least near said rear end (18) and adapted for providing a channel (12) allowing a said product to be introduced near said horizontal cut; a soil flap lifting part (11) adapted for lifting said soil flap (16), said soil flap lifting part (11) coupled to said blade (10), and provided between said front cutting edge (17) and said channel forming part (12); a vertical cut following part adapted for allowing said soil-opener (3) in operation to follow said functionally vertical cut, said vertical cut following part coupled to said blade (10) and extending at least to said front cutting edge (17).

### FIELD OF THE INVENTION

The invention relates to a soil-opener, a soil opener system, and a method for opening soil for introducing a product into the soil.

### BACKGROUND OF THE INVENTION

Soil-openers are well-known in the art and have been used since man works the land.

Despite this long development, only in as recent as 1925 was a new type of soil-opener presented. U.S. Pat. No. 1,556,899 by Elva L. Bell discloses a soil-opener which was to become known as the “inverted-T”. According to the document, “This invention has relation to a combined drill tooth and hoe and more particularly to a device capable of attachment to a drag bar of a grain drill which cut the weed's below the surface of the ground, open a furrow, drop a seed therein and cover the seed by the dirt which is permitted to roll back into the furrow. The special adaptation of my invention selected for the purpose of illustrating the same is its use in a grain drill in which a series of draw bars are pivotally attached to a, frame work and capable of being lifted from the ground for the transportation thereof, said drawbars having a capability of independent movement and held spring pressed toward the ground. The machine is provided with means for feeding grain in small quantities, as it progresses across prepared ground.”

More recently, several patents have been published in the name of John Christopher Baker. FR2236402 of 1974 in its abstract describes “The purpose of the process is to sow seed by the direct or sod seeding method which involves minimal soil disturbance, and therefore minimal water loss. The fundamental idea is the retention of an unbroken layer of soil above the layer of broken soil in such a way as to leave the areas for optimum growth undisturbed. This is achieved by using a vertical stem of narrow section. At the lower end of the vertical stein is a horizontal blade so arranged as to draw the soil turner downwards into the soil. These two components are attached to a support.”,

Many others discloses alternatives and improvements to the inverted-T soil opener were disclosed by Baker, For instance in FR13499474 and U.S. Pat. No. 5,850,790. The part is also referred to as a ‘Baker Booth’.

Recently, further developments have been disclosed.

WO2014117210 in its abstract describes “A seeding boot, for a seeding apparatus mountable on a tyne, or adjacent a soil-opening disc, of a tillage implement, has a hollow boot body mountable adjacent the lower end of the tyne or lower portion of the soil-opening disc. A seed distributor in the boot body has a seed inlet connectable to a source of seeds; at least one seed outlet spaced laterally from the tyne or soil-opening disc; and at least one fertiliser or chemical distributor located rearwardly of the tyne or the soil-opening disc. The seed outlet(s) are provided at, or adjacent, the distal ends of laterally-extending hollow wings, which extend from the seed distributor. When two fertiliser or chemical distributors are provided, the first distributor is connected to “dry” or “granular” fertiliser; while the second distributor is connected to “liquid” fertiliser or chemical(s); the outlet from the second distributor is located intermediate the tyne or soil-opening disc and the outlet from the first distributor; and the outlets of the first and second distributors are at a reduced depth in the soil relative to the seed outlet(s).”

US2009/013910 in its abstract describes “A double shoot seed and fertilizer placement unit has a leading shank that cuts a fertilizer trench in the soil, a seed shovel immediately behind but above the lower extremity of the shank to cut one or more seed shelves in the soil above and outboard of the fertilizer trench, a boot behind the shovel that places seeds on the shelf and then drops fertilizer into the fertilizer trench between and below the seeds, and a fertilizer guide member that rides in the fertilizer trench below the fertilizer outlet to maintain the integrity of the trench in preparation for the fertilizer and helps guide the fertilizer down to the bottom of the trench as it emanates from the boot.”

WO2008/040113 in its abstract describes “Apparatus for controlling the placement of seeds deposited by a seed placement device in a furrow. The apparatus comprise a guide member connected to the seed placement device adjacent an exit of the seeds from the placement device adapted to urge seeds discharged from the exit toward a sidewall of the furrow. The guide member of the present invention acts to stop seeds from bouncing off the sidewalls of the furrow and into the centre of the furrow. The guide member organizes the seeds to create one or more seed rows where the seeds are optimally positioned and prevents seeds from ending up in the middle of the furrow. If a fertilizer row is present below the seed furrow, this prevents damage to the seeds by preventing them from being too close to the fertilizer. The guide member also stops the seeds from being swept back into the central region of the furrow with the loose soil that flows back into this area after the knife implement has passed.

US2009/308296 in its abstract describes “An opener for mounting on a shank of an agricultural implement features a central body to be mounted on the shank, furrowing portions carried on the central body to form a seed bed as the central body is pulled through ground on the shank in a forward working direction, a seed delivery passage operable to deliver seed onto the seed bed from a seed outlet on a first side of the central body, and a fertilizer delivery passage operable to deliver fertilizer onto the seed bed from a second side of the central body. In use, the opener delivers the seed and the fertilizer onto the same seed bed on opposite sides of the central body. A rubber cover seals closed an upper end of the central body to prevent moisture from anhydrous ammonia tubes from dripping into the body, and is adaptable to accommodate seed tubes of different diameters.”

It was found that the proposed soil-openers could use further improvement.

### SUMMARY OF THE INVENTION

Hence, it is an aspect of the invention to provide an alternative soil-opener, which preferably further at least partly obviates one or more of above-described drawbacks.

There is currently provided a soil-opener for in operation providing a functionally horizontal cut at a depth from a soil surface in a functionally vertical cut into soil for providing a soil flap for introducing a product into said soil, said soil-opener comprising:
a blade having a front cutting edge for in operation cutting said functionally horizontal cut, a rear end, a blade width, and said blade arranged for cutting soil functionally cross with respect to a said functionally vertical cut;
a channel forming part coupled to said blade, said channel forming part adapted for providing a channel allowing a said product to be introduced near said horizontal cut;
a soil flap lifting part adapted for lifting said soil flap, said soil flap lifting part coupled to said blade, and provided between said front cutting edge of said blade and said channel forming part;
a vertical cut following part adapted for allowing said soil-opener in operation to follow said functionally vertical cut, said vertical cut following part coupled to said blade and extending at least to said front cutting edge and opposite said rear end,
   wherein said blade between said front cutting edge and said rear end has a widest part, said widest part is forward of the rear end of the blade, forward of said channel forming part near said rear end of the blade, at a front half of said blade, wider than said channel forming part near said rear end of the blade,
   wherein said channel forming part ends near said rear end of said blade,
   wherein a channel distance is 2-7 times a channel width, wherein said channel width is defined as a width of said channel forming part near said rear end of said blade and said channel width is parallel to a line through said widest part of said blade and wherein said channel distance is defined as a distance between said widest part of said blade and said channel forming part near said rear end and said channel distance is determined normal with respect to said blade width, and
   wherein said blade width at said widest part of said blade is 1.2-5 times a channel width.

It was found in extensive testing on many types of soil, that the proposed soil-opener was able to cut a soil flap for each soil condition.

It allows lifting up a flap of soil, allow introducing a product into the soil. Such a product can comprise a liquid, which may be injected. Other products comprise one or more fertilizers, seeds, seedlings, selective herbicides, pesticides, manure slurry, and a combination thereof. After introduction of the product, the flap of soil is closed again, leaving the soil surface as undisturbed as possible. Thus, a product can be introduced into the soil with low disturbance of said soil.

The vertical cut following part is provided for allowing the soil-opener to follow a direction of the vertical cut. The vertical cut further has a depth and a width. The vertical cut follower part may be wider that the width of the vertical cut, or may reach deeper. In order to keep disturbance of the soil as little as possible, it is preferred to also disturb the vertical cut as little as possible. In fact, both the vertical cut as well as the horizontal cut will be more like incisions, causing low disturbance of the soil.

Such a vertical cut has a longitudinal cut direction following said cut, and a downward or transverse direction into the vertical cut. Further, the vertical cut has a cut width. The blade can have a tip. The blade has a longitudinal line running through the tip and the rear end. It usually defined the start of the horizontal cut. This line is also referred to as the centre line. Usually, the centre line is at a centre of the vertical cut, and is at a section of the vertical cut plane and the horizontal cut plane. The blade, however, does not need to be mirror-symmetric about this centre line. In fact, the blade can extend to only one side of this centre line. The blade extends in transverse direction and has an upper blade surface which in use is directed towards the soil surface and a lower blade surface opposite the upper blade surface. The front cutting edge of the blade often is angled, giving the blade a tip.

In an embodiment, the width of said widest part of said blade is 1.5-4 times said channel width.

In an embodiment, the width of said widest part of said blade is 1.8 to 3 times said channel width.

In an embodiment, the channel distance is 2.5-6 times said channel width.

In an embodiment, the channel distance is 3-5 times said channel width.

In an embodiment, the soil-opener comprises a centre line, a rear end, a blade width defined normal with respect to said centre line and defining a cut width of said functionally horizontal cut, and said blade arranged for cutting soil functionally cross with respect to a said functionally vertical cut.

In an embodiment, the blade when going from the widest part to its rear end has a width that is at least the width at said rear end. It can for instance run in a straight line

In an embodiment, the blade width at its widest part is between 1.2 to 5 times the width of said blade at said rear end.

In an embodiment, the blade width at its widest part is between 1.5 to 4 times the width of said blade at said rear end.

In an embodiment, the blade width at its widest part is between 1.5 to 3 times the width of said blade at said rear end.

In an embodiment, the blade width at its widest part is between 1.5 to 2.5 times the width of said blade at said rear end.

It was found that the shape provides optimal effect and reduced soil disturbance.

In an embodiment, the blade width at said widest part is more than 1 cm, in particular more than 2 cm. In an embodiment, the width is at the widest part is at least 2.5 cm, in particular at least 5 cm.

In an embodiment, the width at the widest part is less than 10 cm.

In an embodiment, the widest part of the blade is at least 5 cm in front of said rear end.

In an embodiment, the blade has a blade length and a front half including said cutting edge, and has its widest part at a front half of said blade, in particular in a front quarter of said blade. The blade in an embodiment is between 5 and 20 cm long. In particular, it is 10-20 cm long.

The different measures and sizes mentioned above provide less disturbance for particular types of soil.

In an embodiment, the soil-opener further comprises a support element attaching said blade, said channel forming part, said soil flap lifting part, and said vertical cut following part together.

In an embodiment, the soil flap lifting part comprises a wedge extending from said channel forming part and from said blade. In particular, said wedge extends from a surface of said blade director to said soil flap.

In an embodiment, the wedge is at least partially formed by a soil wedge formed by soil which in use gets collected on said blade surface and a ridge functionally perpendicular to said blade surface and extending substantially at said rear end of said blade.

In an embodiment, the cut-following part has a leading edge for in operation extending into said functionally vertical cut. In particular the leading edge is straight. In an embodiment, the leading edge extends functionally perpendicular to said blade.

In an embodiment, the channel forming part has a width extending from near said rear end of said blade toward a top of said soil-opener. In particular said width of said channel forming part is at least a width of said blade at said rear end. In particular said channel forming part extending opposite at a distance from said cut-following part and extending in a longitudinal direction substantially parallel to said leading edge for providing a channel in a said vertical cut substantially down to said horizontal cut.

In an embodiment, the soil-opener comprises the support element, wherein said support element comprises a plate element having a leading edge providing a said vertical cut following part, a trailing edge opposite said leading edge connected to said channel-forming part, and an adjacent lower side holding said blade. A plate element makes the soil-opener relatively easy to produce.

In an embodiment, the blade is attached to the plate element, said blade extending at least near said lower side and along said lower side and arranged for cutting soil functionally cross with respect to said plate element.

In an embodiment, the soil-opener further comprises a conduit having an outlet at or near said widest part of said blade.

In an embodiment, the blade extends in both sides of said vertical cut following part for providing horizontal cuts in both opposite soil walls of said functionally vertical cut. This allows deposition of product at separate positions remote from one another. Even more that two products can be deposited each a distance apart from one another. The horizontal cuts can be on the same depth, or at different depths.

In an embodiment, the channel forming part extends at both sides of said vertical cut following part.

In an embodiment, the channel forming part comprises at least two product lines for introducing product into said channel, one product line extending into said channel and comprising a sideward bent arranged for introducing said product underneath said soil flap, in particular in a soil channel near a bent of said flap.

In an embodiment, wherein said blade has a blade thickness of 3-8 mm. In a further embodiment, the blade thickness is 3-6 mm.

In an embodiment, the vertical cut following part has a vertical cut following part thickness of 3-10 mm. In an embodiment, the vertical cut following part has a vertical cut following part thickness of 5-9 mm.

In an embodiment, the blade has a blade length of 10-20 cm.

The invention further pertains to a soil-opening system comprising the soil-opener, further comprising:
a soil-cutter for in operation providing a functionally vertical cut into a soil;
said soil-opener coupled to said soil-cutter, with its leading edge towards said soil-cutter and in line with said soil-cutter, and
a depth-setter coupled to said soil-opener for maintaining a set cutting depth of said blade.

In an embodiment, the soil-opening system, further comprises:
a soil-closer, coupled to said soil-opener at a distance from its training end and functionally in line with said blade for in operation applying pressure on soil behind the soil-opener for closing the soil.

In an embodiment, the soil-cutter comprises a water cutter, said soil cutter positioned on said soil-opening system for in operation providing a vertical cut parallel and in line with said soil-opener leading edge. In an embodiment, the water cutter provided for in use providing a cutting water beam at 0-10 cm in front of said leading edge. In an embodiment, the water beam is 0.5-7 cm in front of said leading edge.

In an embodiment, the vertical cut following part having substantially the same width as the cutting device placed in front of it.

The invention further pertains to method for depositing a product into a soil using the soil-opener, the method comprising cutting a functionally vertical cut into soil, directing said soil-opener into said functionally vertical cut with its blade cutting functionally cross with respect to said vertical cut for providing a soil flap, advancing said soil-opener in said cut behind said soil-cutter, resulting in a lifting of said soil flap and producing a channel behind said soil-opener and extending at said lifted soil flap, depositing product into said channel, and allowing said soil flap to close.

In an embodiment a further product is deposited into said channel, wherein said further product is deposited at a distance from said product, in particular said one of said products is deposited at said vertical cut near said cut from said blade, and the other of said products in said cut from blade away from said vertical cut, below said soil flap.

The invention further pertains to an inverted-T soil-opener comprising a functionally horizontal blade wherein said functionally horizontal blade between a front cutting edge and a rear end has a widest part which is 1.2 to 5 times wider than a width of said blade at said rear end.

The invention further pertains to a soil-opener for in operation providing a functional horizontal cut at a depth from a soil surface in a functionally vertical cut into soil for providing a soil flap for introducing a product into said soil, said soil-opener comprising a blade having a front cutting edge for cutting said functionally horizontal cut, a rear end, a blade width, and arranged for cutting soil functionally cross with respect to a said functionally vertical cut, a channel forming part coupled to said blade, ending at least near said rear end and adapted for providing a channel allowing a said product to be introduced near said horizontal cut, a soil flap lifting part adapted for lifting said soil flap, said soil flap lifting part coupled to said blade, and provided between said front cutting edge and said channel forming part, a vertical cut following part adapted for allowing said soil-opener in operation to follow said functionally vertical cut, said vertical cut following part coupled to said blade and extending at least to said front cutting edge, wherein said blade between said front cutting edge and said rear end has a widest part which is between 1.2 to 5 times a width of said blade at said rear end.

The invention further pertains to an inverted-T soil-opener comprising a functionally and in use horizontal blade for cutting a soil flap at at least one side of a vertical soil cut, and a soil flap lifting part for lifting up said cut soil flap for providing a sub-surface channel for product, in particular selected from seed and fertilizer, and lowering said soil flap for closing said sub-surface channel, for sub-surface depositing of said product at low soil disturbance.

The invention further pertains to n inverted-T soil-opener comprising a functionally horizontal blade, wherein said functionally and in use horizontal blade has a centre line and between a front cutting edge and its rear end has a widest part, defined normal from said centre line, which is at least 1.2 to 5 times wider than a width, defined normal from said centre line, of said blade at said rear end.

The term “substantially” herein, such as in “substantially vertical” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices or apparatus herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device or apparatus claims enumerating several means, several of these means may be embodied by one and the same item of hardware. The mere fact that certain measures are recited in mutually different dependent claims does not indicate that a combination of these measures cannot be used to advantage.

The invention further applies to an apparatus or device comprising one or more of the characterising features described in the description and/or shown in the attached drawings. The invention further pertains to a method or process comprising one or more of the characterising features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1-4 schematically depict an embodiment of the soil-opening system in rear perspective view, font perspective view, and two opposite side views;

FIGS. 5-6 in perspective view various active parts of FIGS. 1-4 acting on soil;

FIGS. 7-8 a soil opener with product introduction device;

FIGS. 9-11 a cross sectional view showing the effect of opening soil and introduction of product via a channel into opened soil;

FIGS. 12-21 various embodiments of soil-openers in various aspect views, with FIG. 14A a view of FIG. 14 from below;

FIG. 22 sowing a soil wedge formed on a soil-opener in use;

FIG. 23 an alternative embodiment of FIGS. 5 and 6 is shown, with a water cutter instead of a mechanical cutter, in perspective view;

FIG. 24 the embodiment of FIG. 23 in front view;

FIGS. 25-27 embodiments of a soil-opener with an incorporated conduit for a liquid component like liquid fertilizer;

FIG. 28 a cross section, perpendicular to the cuts made by a prior art soil-opener, of soil treated with prior art soil-openers, and

FIG. 29 a cross section, perpendicular to the cuts made by a current soil-opener, of soil treated with the current soil-openers.

The drawings are not necessarily on scale

### DESCRIPTION OF PREFERRED EMBODIMENTS

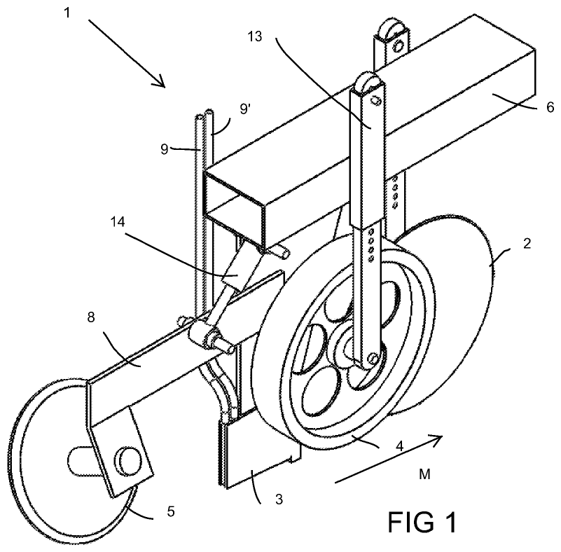

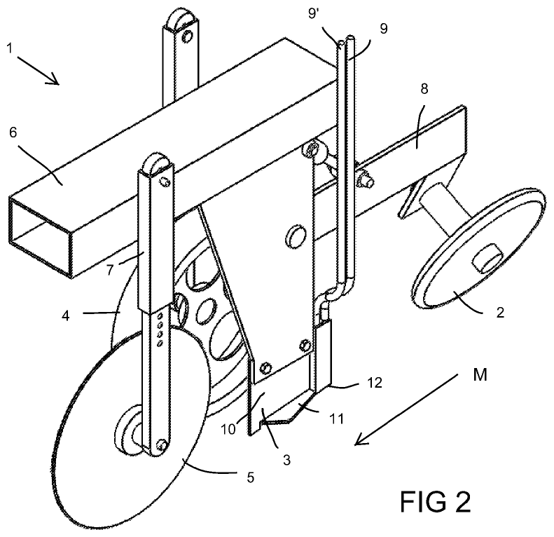

FIGS. 1-4 schematically depict an embodiment of the soil-opening system 1 in rear perspective view, font perspective view, and two opposite side views, respectively.

In general, a soil-opening system 1 comprises several active parts or components, indicated 2, 3, 4 and 5 that are here mutually coupled via a frame 6. The frame 6 serves to hold these parts mutually positioned during use, and is here indicated in a general way. The various active parts 3-5 here comprise a soil-cutter 2, a soil-opener 3, a depth-setting element 4 and a soil-closer 5.

In operation, the soil-opening system 1 will be moved in the direction indicated by arrow M in FIG. 1. In this way, the soil-cutter 2 will cut a vertical cut into the soil, the soil-opener 3 will proceed or advance into or though the cut, soil-closer 5 will close the soil, and depth-setting element 4 will determine or set the depth of the functionally horizontal cut. Usually, in operation a product, like seed, fertilizer, or manure, is introduced via a channel into the opened soil. Such a product may be liquid or solid. Via a product line 9, 9′ the product is transported through the channel and to the horizontal cut. The depth of the horizontal cut is thus of importance. The process will be explained in more detail below.

In the depicted embodiment, the soil-cutter 2 is a known cutter wheel. This is in fact an example of a mechanical cutter. The function of such a soil-cutter 2 in the current soil-opening system is to provide cut into the soil which is functionally vertical and which is as sharp as possible and disturbed the soil as little as possible. In an alternative embodiment, the soil-cutter 2 can also be of a non-mechanical nature. An example of such a non-mechanical soil-cutter 2 is for instance a water jet. Such a water jet is generally known as a cutting device, although not in the current context for cutting soil and in particular not as a part of a soil-opening system 1.

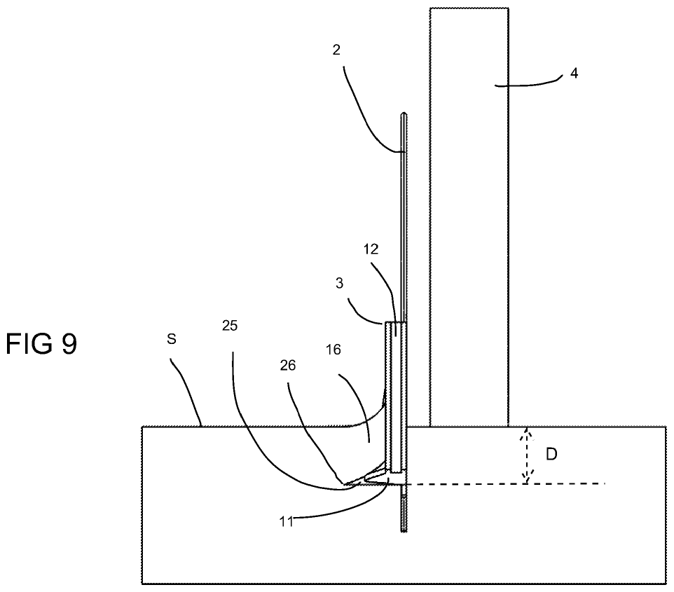

In the depicted embodiment of FIGS. 1-4, the depth-setting element 4 is a mechanical element. In the depicted embodiment, in particular the depth-setting element is a wheel, also called or referred to as a gauge wheel. The depth-setting element is here coupled to the frame 6 via a depth-setting actuator 13. This depth-setting actuator 13 can be relatively passive, allowing for instance a manual sitting of the (vertical) height of the depth-setting element 4. More advanced implementations of the depth-setting actuator 13 are also possible, like an active depth-setting actuator. In such an embodiment, for instance a hydraulic cylinder sets the (vertical) position of the depth-setting element 4. Such a depth-setting actuator may be operated from a distance, like from inside a tractor, or may even be operated automatically via a controller. Thus, a controller may adjust the actuator during operation. In advanced embodiments, the depth-setting element 4 may also be of a non-mechanical nature. An example may comprise a laser distance-measuring device or an ultrasound distance measuring device for measuring a distance to the soil surface, and an actuator functionally coupled to the distance-measuring device for setting and maintaining a frame height of frame 6 with respect to the soil surface during operation. As the soil-opener 3 is in fact also coupled to the frame 6, the depth-setting element in fact sets and/or maintains the depth of the blade 11 with respect to the soil surface S and thus of the horizontal cut. This may comprise a feedback loop. In FIG. 9, this depth D is indicated.

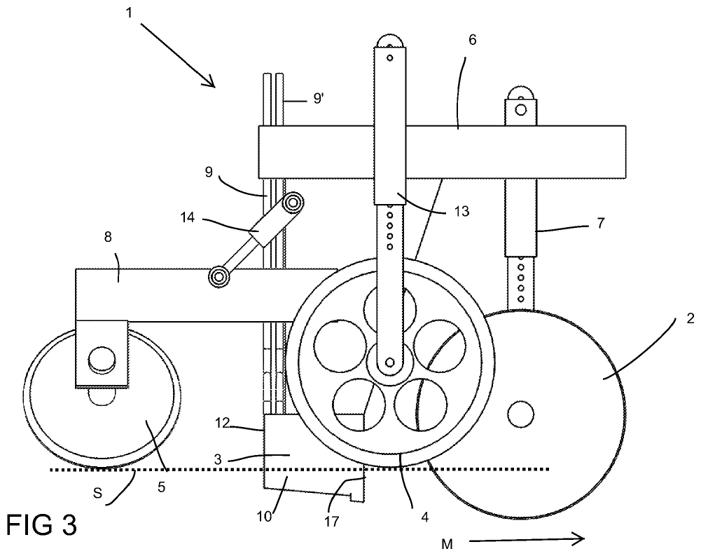

In the depicted embodiment of FIGS. 1-4, a soil-closer 5 is included on the soil-opening system 1. The opened soil may actually close behind the soil-opener 3 by itself, but for a more secure closing of the soil, a soil-closer 5 may be provided as indicated. In the current embodiment, the soil-closer 5 comprises a wheel that presses on the soil behind the soil-opener 3. In the embodiment depicted here, the soil-closer 5 is coupled a soil-closer frame 8. In the depicted embodiment, the soil-closer frame 8 comprises a moveable arm that at one end is coupled to the frame 6, and on its opposite end holds the soil-closer 5. The weight of the arm and soil-closer 5 may provide a pressure that presses on the soil to close it. Here, in addition a soil-closer setting 14 is provided. The soil-closer setting 14 is coupled to the frame 6 and to the arm 8 between the rotational position and the end holding the soil-closer 5. It can provide a pressure force pushing the arm and thus the soil-closer 5 downward, pressing the soil-closer 5 with an additional force onto the soil surface S (indicated in FIG. 3). The soil-closer setting 14 can (again) be a passive element, providing downward pressing force. Alternatively, the soil-closer setting 14 can comprise a hydraulic cylinder setting the position of the soil-closer 5, or pressing it down on the soil surface S with a force that can be set manually, or remotely. The force or position can even be set from a distance, or even remotely. In an embodiment, the soil-closer setting 14 may be controlled via a controller. In such an embodiment, a controller may adjust the setting during operation.

In an embodiment, the depth-setting element 4 can be combined with the soil-closer. In such an embodiment, the depth-setting element 4 is a mechanical element that contacts the soil surface and applies pressure to the soil surface. For instance, the wheel 4 depicted in FIGS. 1-4 can take the position of the depicted soil-closer 5.

In the depicted embodiment of FIGS. 1-4, the soil opener 3 is coupled to the frame 6 via a soil-opener coupler 15. In a soil-opener system 1, the soil-opener 3 will in general be a replacement part that is replaced after some use, because it is subject to intensive wear. To that end, the soil-opener is provided with an attachment end 31. At said attachment end 31, usually opposite an end holding said blade, the soil-opener 3 is provided with an attachment provision.

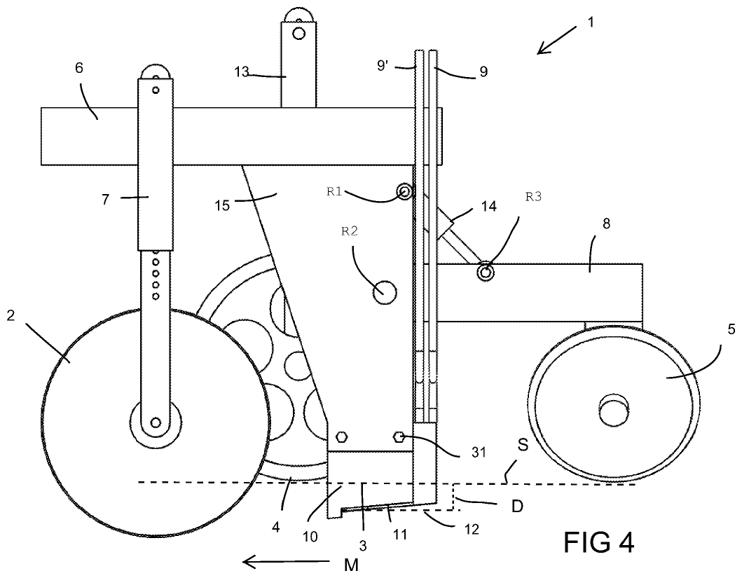

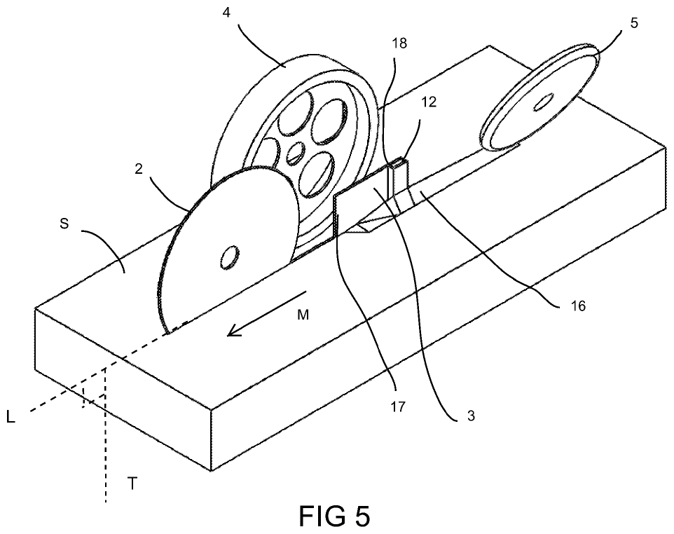

In the current embodiment, the soil-opener coupler 15 is a plate element which at one end is connected to the frame 6, and at an opposite end is connected to one end of the soil-opener 3, see FIG. 4. In this figure, the soil-closer setting 14 is at one end rotationally coupled at hinge R1 to the soil-opener coupler 15. The soil-closer frame 8 is at one end rotationally or hingingly coupled at hinge R2 to the soil-opener coupler 15. Here, the rotational axis R2 of the soil-closer frame 8 is below rotational coupling R1 of the soil-closer setting 14. The soil-closer setting 14 is here a hydraulic cylinder set for pressing the soil-closer onto the soil surface S.

The soil-opening system further comprises in the current embodiment the product line 9. In operation, the soil-opening system 1 opens a channel 12 into the soil where a product can be deposited. The product line 9 in an embodiment transports the product into that channel 12.

The soil-cutter 2 of the current embodiments is coupled to the soil-opener 3. In the current embodiment, the soil-cutter 2 is attached to frame 6. In order to set a cutting depth, the soil-cutter is attached to the frame 6 via a depth-setting part 7, in the current embodiment a passive, mechanical depth-setting part 7. In an alternative embodiment, the depth-setting part 7 can be set manually, as indicated in FIGS. 1-4. In another embodiment, the depth-setting part may be an active part. It may comprise an actuator that is functionally coupled to a controller. The controller may set the cutting depth independently from the soil-opener 3. The soil-opening system 1 may comprise a measuring device for measuring a soil surface position, and which may be functionally coupled to said controller. In response to a soil surface position, the controller may control the actuator of the depth-setting part for actively setting a cut depth.

In FIG. 5, the working of the various operational elements 2-5 is illustrated. The soil-cutter 2 cuts a (functionally) vertical cut into the soil. The soil surface S is indicated. The soil-opener 3 follows the soil-cutter 2 in the provided cut. The soil-opener 3 has a leading edge 17 and a trailing edge 18. Its blade 11 (explained later) will make a horizontal cut, producing a soil flap 16 that will be lifted or hinged a little. Next, soil-closer 5 will press the soil-flap 16 closed again.

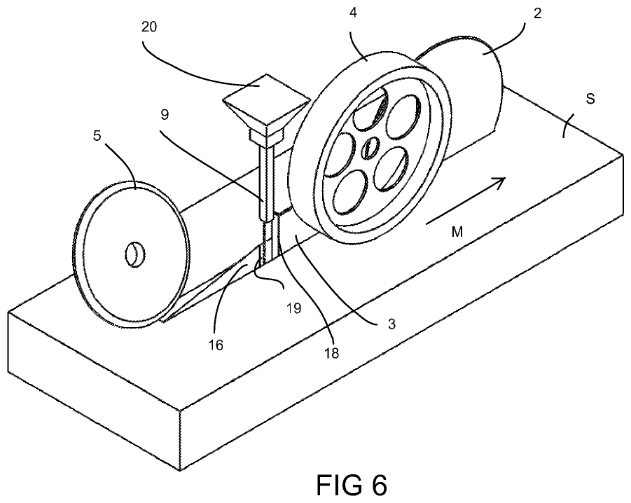

In FIG. 6, the soil-opening system is depicted in operation from its other side, with the product line 9 and a product dispenser 20 (schematically). At an end of the product line 9, product 19 falls into channel 12 behind the soil-opener 3.

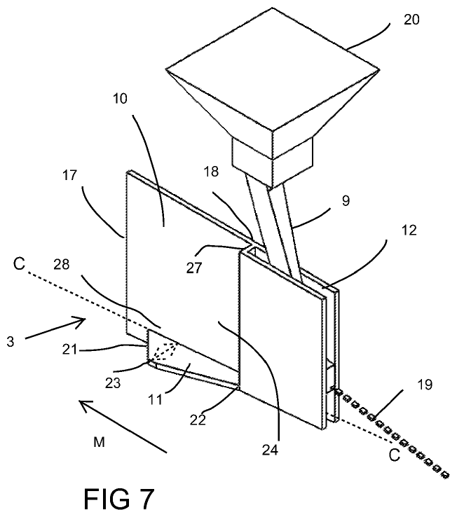

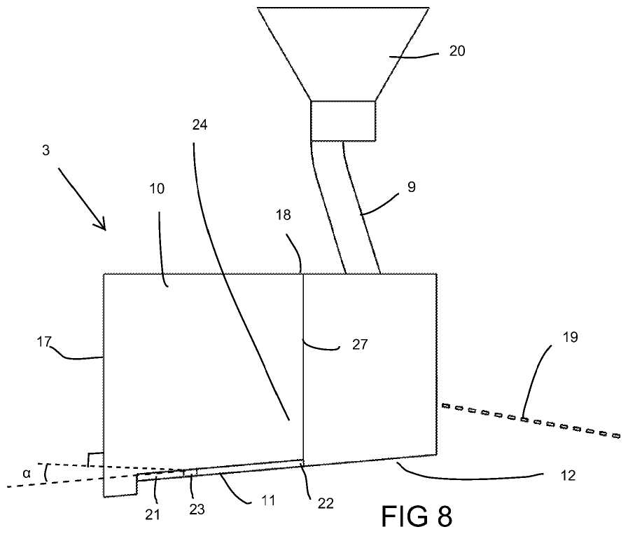

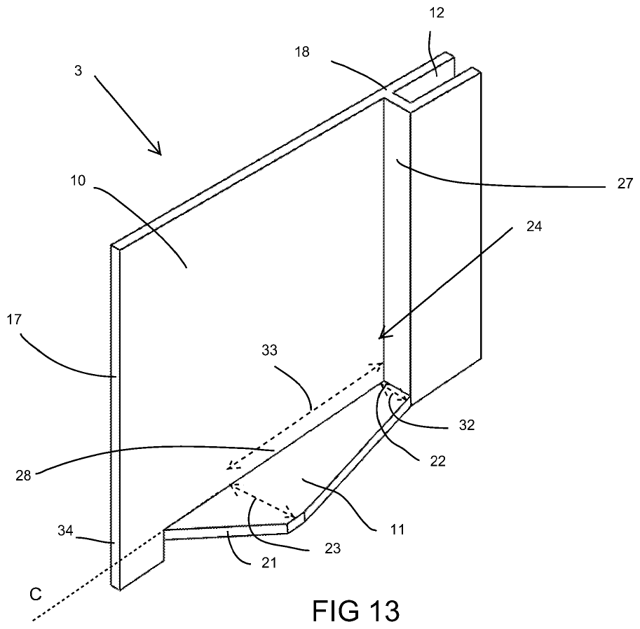

In FIG. 7, the mutual alignment of the product line 9, soil-opener 3 and the channel 12 is depicted in perspective view, and the same elements are shown in FIG. 8 in side view. The soil-opener 3 will be discussed in more detail below, in relation to FIGS. 8-22, showing several embodiments.

In the embodiments depicted, the soil-opener 3 has a support element that comprises a plate element 10. The plate element provides many functions to the soil-opener 3 in a simple way. The plate element 10 can be lowered and inserted into the vertical cut. When the soil-opener 3 is in operation, the plate element 10 can smoothly nm into the vertical cut. The plate element 10 has a leading edge 17 and a trailing edge 18. In operation, the leading edge 17 will be in the front and the trailing edge 18 will be in the rear. The direction of motion M, in operation, is also indicated here for clarification. The plate element 10 further has a plate element lower end or side 28. In operation, as also visualised in FIG. 5, the plate element 10 follows the soil-cutter 2 in the cut, with the leading edge 17 closest to the soil-cutter 2. The plate element lower side 28 is down in the vertical cut. The plate element provides a support element holding or incorporating various functional parts. For simplicity, often the plate will be continuous. In an embodiment, parts of the plate element can be removed for instance to reduce drag. The plate element 10 can have a width and height adapted to the dimensions of the vertical cut. In an alternative embodiment plate element 10 can be wider that the vertical cut width and reach deeper than the vertical cut.

The soil-opener 3 further comprises a blade 11 at or near the plate element lower side 28. In an embodiment, the blade 11 is provided at the plate element lower side 28.

Blade 11 has a blade front cutting edge 21 and a blade rear end 22. Between the blade front cutting edge 21 and the blade rear end 22, the blade 11 has a widest part 23. The width of blade 11 at the widest part 23 is at least 1.2 times the width of the blade at the blade rear end 22.

Blade 11 is connected or fixed to the plate element 10 with its blade cutting edge 21 directed towards the leading edge 17 of the plate element 10 and the rear end 22 at or near the trailing end 18 of plate element 10. The blade 11 has a longitudinal axis connecting the tip of the blade 11 with the rear end 22.

The blade 11 is provided for cutting soil functionally cross with respect to the cut that is made by the soil-cutter 2. The function of the blade 11 is to provide a functionally horizontal cut in such a way that a slab of soil 16 is created. The direction may also be defined as laterally with respect to the vertical cut. Advancing of the soil-opener 3 results in a slight lifting of the soil-flap 16. This will be further explained in discussing FIG. 9.

The blade 11 in the current embodiment of FIGS. 7 and 8 extends on one side of the plate element 10. Here the actual angle between the blade 11 and the plate element 10 determines or sets an angle of the functionally horizontal cut with respect to the functionally vertical cut.

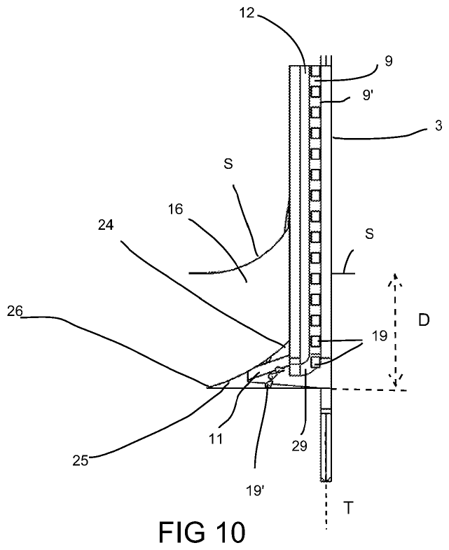

Before discussing further parts of the soil-opener 3, first the working of the soil-opener 3 will be explained. This is visualised in FIGS. 9 and 10.

It was explained above how the soil-cutter 2 first makes a substantially vertical cut into the soil, in such a way that the soil further remains as undisturbed as possible. The soil-opener 3 follows behind the soil-cutter 2, with plate element 10 running through the fresh vertical cut. The blade 11 starts cutting into the soil almost perpendicular to the substantially vertical cut. The intention is to create a soil flap 16 as indicated in FIG. 9. The leading edge 17 of the plate element 10 in the current embodiments runs perpendicular to the blade 11. The leading edge 17 is part of the vertical cut following part. In an alternative embodiment, the leading edge part 17 may extend at an angle (towards or away from the rear end of the blade 11) with respect to the longitudinal direction (a line connecting the tip and the rear end) of the blade 11.

As already explained, the depth D of the horizontal cut (see FIG. 9) with respect to the soil surface level is set by the depth-setter 4. In the embodiments of FIGS. 1-4

The soil-opener 3 further is provided with a soil flap lifting provision. An effect of this soil flap lifting provision is that the soil flap is lifted in such a way that it in fact hinges about a soil bending region. The lifting of the soil flap can be effected by a physical wedge at wedge region 24, or via provisions that create a soil wedge at wedge region 24 during use.

Furthermore, the soil-opener 3 is provided with a channel-forming part 12 at the trailing edge of the plate element 10. An effect of this channel-forming part 12 is that a small end behind the plate element trailing end 18 the soil flap remains lifted, and only closes some end behind the plate element trailing end 18. In this way, some space is created where a product can be deposited. In FIG. 10, for example, a granular material is deposited, like seeds or fertilizer. Alternatively, a liquid product can be deposited. This can be liquid fertilizer, manure, or even water that is added to seeds, creating a moist, underground ribbon. In particular in FIG. 10, two product lines 9, 9′ are schematically depicted. There may be even more product lines. These product lines 9, 9′ are positioned for bringing product 19 and 19′ into the vertical cut and to the horizontal cut region below the soil flap. In some cases, products 19, 19′ should to be in contact. For instance, seeds and fertilizer often should be close together, but not in contact. In the embodiment of FIG. 10, ends of product lines 19, 19′ are a distance apart, of depositing products at spaced-apart regions. Here, one product line 9′ has a bent 29. In general, the product line opens in a lateral direction, towards the horizontal cut It this opens in the direction of the blade width or transverse direction of the blade 11. In the current embodiment, the product line 9′ extends into the horizontal cut up to as far as the widest part from the vertical cut. It thus allows depositing product 19′ even up to the bent region 26 of the soil flap. This physically separates products 9, 9′.

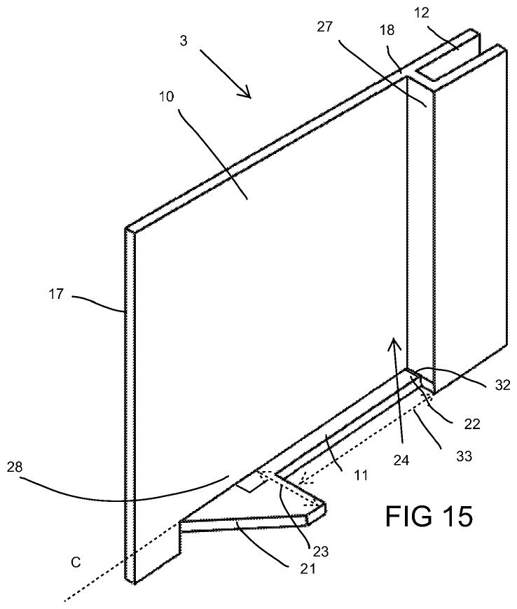

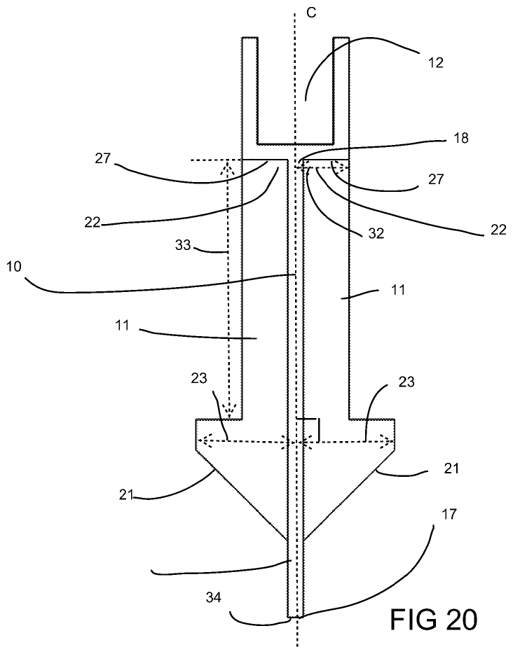

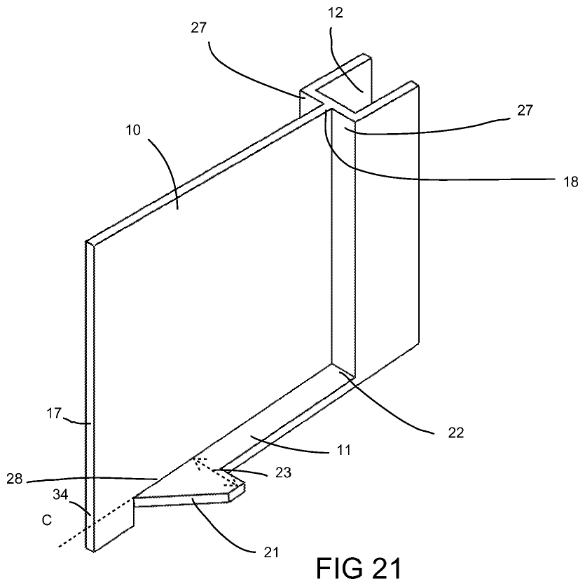

In a general embodiment, the channel forming part 12 comprises a widening of the soil-opener 3 at or behind the rear end of the blade 11. In the embodiment of FIGS. 7-10, the channel-forming part 12 is a widening of the soil-opener 3 that is formed by two substantially parallel plates at a distance apart. Between the plates, a space is formed where product may be dropped. In the embodiment of FIGS. 7 and 8 (but also in FIGS. 1-6), one or more product lines 9, 9′ are provided that extend at least between the plates of the channel forming part 12. As may be seem from FIG. 7, but perhaps even more clearly from FIGS. 15-19, is that in these embodiments the support element comprises plate element 10. The plate element 10 extends beyond the plate element trailing end 18, forming one of the substantially parallel plates of channel part 12. Attached at the trailing end is an L-shaped plate part where one part of the “L” provides the other substantially parallel plate of the channel part 12. In the embodiment of FIGS. 20 and 21, a U-shaped plate element is attached at the trailing end of a plate element 10. The widening of the soil-opener 3 extends at the side of the blade 11.

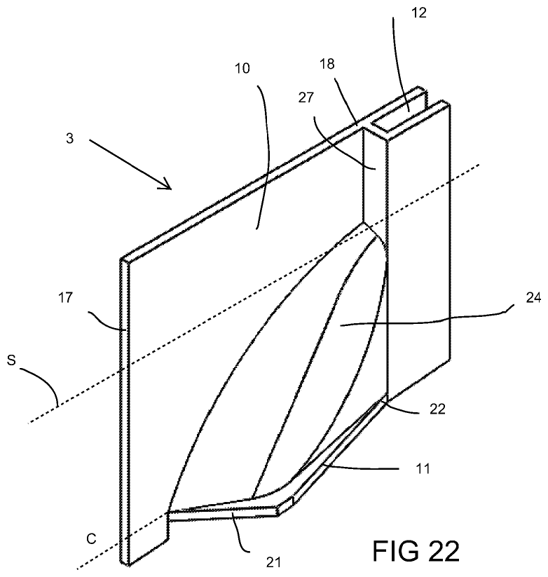

In order to be able to slightly lift the soil flap 16, one option is to provide a wedge at the region indicated with reference number 24. Such a wedge can be a solid wedge, for instance from the material of the plate element. Alternatively, a so called soil wedge can be created during use. The forming of a soil wedge is illustrated in FIG. 22, showing how soil gets compressed at the soil wedge region 24. An advantage of a soil wedge is that wear to the soil-opener and friction during use is minimized. When turning back to the embodiment of FIGS. 7 and 8, the plate element 10 at its trailing end 18 comprises a ridge or blunt end 27. When moving the soil-opener 3 as indicated, an amount of soil will collect at the ridge of blunt edge 27 and in particular at the corner formed by the blunt edge 27 and the blade 11 near its rear end 22. This collected soil will have a shape of a wedge as indicated in FIG. 22. The wedge 24 will slightly lift the end of the soil flap 16. This causes the soil flap 16 to bend at the soil bending region 26. Lifting the soil flap will result in a further soil channel 25. The channel that results from the channel forming part 12 that runs from the soil surface S to near the blade rear end 22 will thus be extended to the soil bending region 26. In this way, product 19 can be deposited below the soil flap 16. The ridge or blunt end 27 can in a practical way result from an end of the widening part of channel forming part 12.

The blade 11, in particular its front region (see FIG. 8) is at an angle α with respect to a line perpendicular to the leading edge of plate element 10. This effect can also be seen in FIG. 9. The angle of attack a of at least the front region of the blade is provided to result in a slight down force that holds the soil-opener in the substantially vertical cut during operation. The angle of attack a as defines can be between −4° and 15°. For providing a sufficient down force, the angle of attack a is in particular between 5° and 10°.

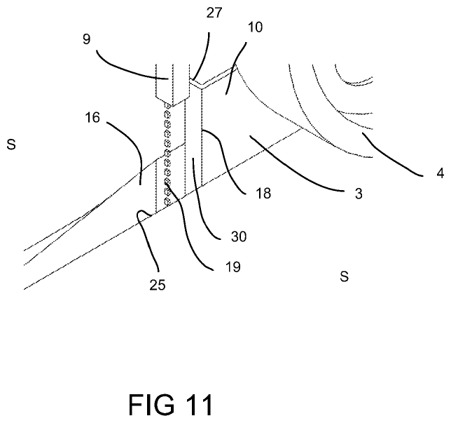

In FIGS. 11-21, various embodiments of soil-openers are presented. In FIGS. 11-19, the blade 11 and channel-forming means are all provided to extend to one side or the plate element 10.

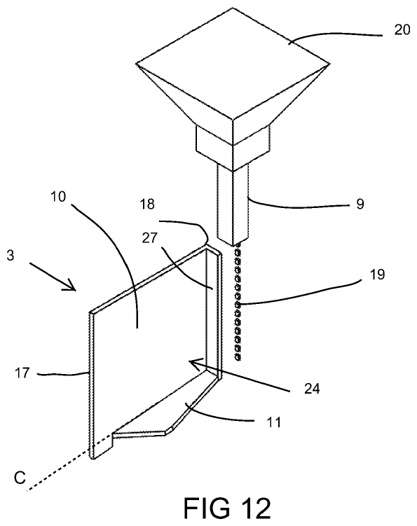

In FIGS. 11 and 12, in fact the soil flap lifting provision and channel-forming means are combined in a relatively simple embodiment. In this embodiment, in fact an end strip of the plate element 10 is bent at functionally 90 degrees, the bending line forming the plate element trailing end 18, a front-facing surface of the bent strip forming the ridge or blunt end for in operation creating the soil wedge, and a rear-facing surface 30 of the bent strip providing a channel behind it. In FIG. 11 it is depicted how product line 9 ends just behind the rear-facing surface 30, and product 19 drops in the channel as the soil flap 16 closes at a distance behind the rear-facing surface 30.

Just like the earlier-discussed embodiments, the blade 11 from the widest part 23 to the blade rear end narrows in a straight line.

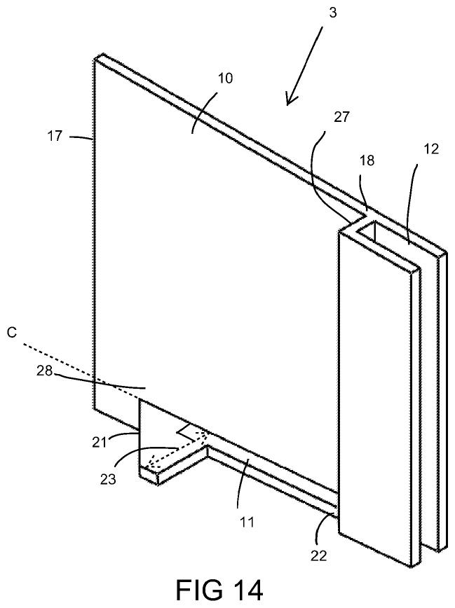

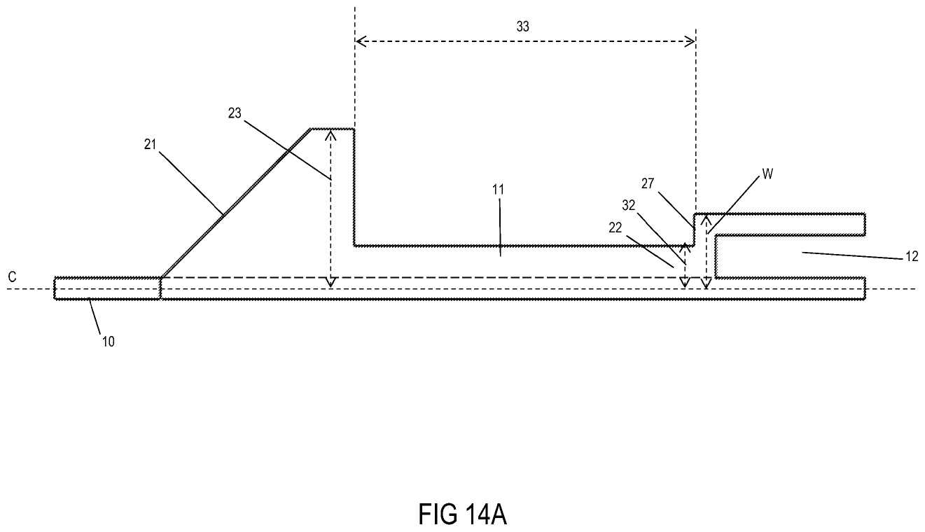

In FIGS. 14 and 15, two perspective views are shown of an embodiment where blade 11 at its widest part 23 narrows abruptly, and in FIG. 14A an upward view of below of the embodiment of FIG. 14 is shown, clearly showing an indication of the channel width W, and the further dimensions. In FIG. 15 it is shown how the rear end of blade 11 is narrower (or extends less from the plate element 10) than the ridge 27. Especially when soil is relatively sticky, this provides a better soil wedge.

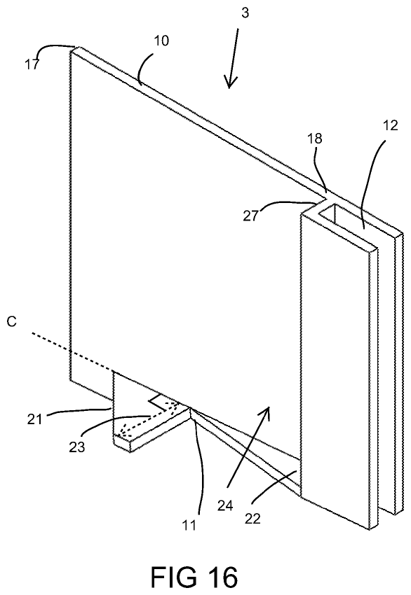

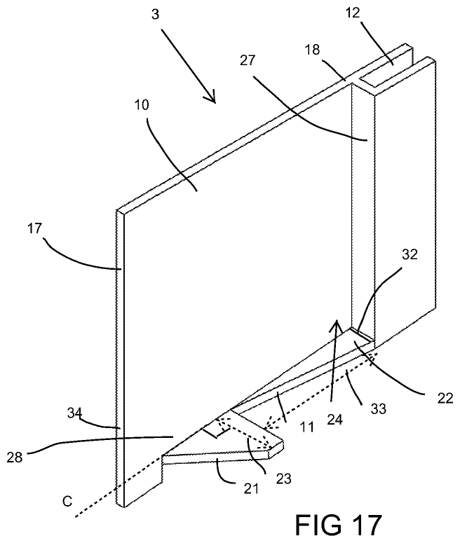

In FIGS. 16 and 17, an embodiment of a soil-opener 3 is depicted where again the blade 11 ends abruptly at or just after the widest part 23. Here, the side edge of blade 11 returns completely to the plate element 10, which in fact created two blade parts. The side edge of the second or rear blade part here in a straight line continues to the ridge 27.

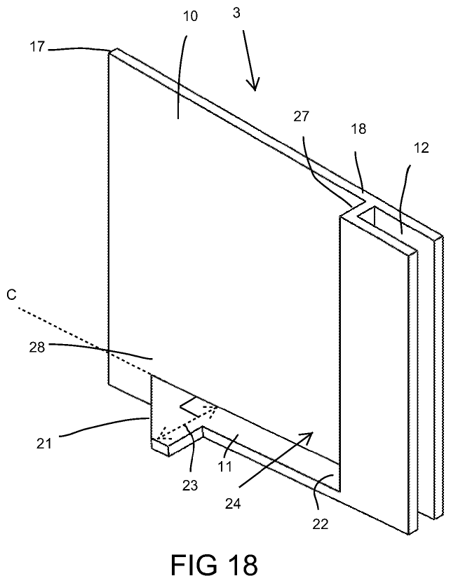

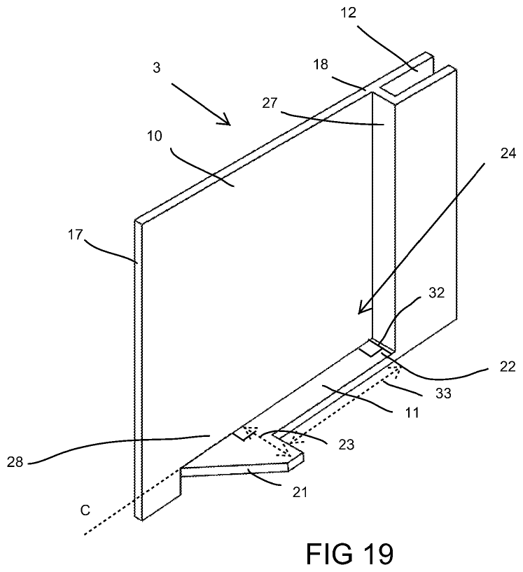

In FIGS. 18 and 19, the blade has a front part comprising the widest part 23. After the widest part, the blade width decreases to a reduced width. The blade 11 then continues substantially the same width up to the rear end of the blade 11. This blade shape proved to be suited as an all-round solution in most soils.

In FIGS. 20 and 21, an embodiment is presented where with blades extending at both sides of the plate element 10, and the channel-forming means also extends to both sides of plate element 10. In this way, two opposite soil flaps are created, providing more space for depositing one or more products. In FIGS. 20 and 21 the blades 11 are at a same height with respect to the plate element 10. In an alternative embodiment, not depicted, the blades may be provided at different heights, for example for deposition two products separately. The blades are here identically shaped as in FIGS. 18 and 19.

The blade 11 in the depicted embodiments are plate-shaped, which is easiest to produce and in operation works effective. The upper and/or lower surfaces of blade 11 have functionally parallel upper en lower surfaces. Alternatively, the blade 11 may have an upper and/or a lower surface that can be profiled in order to improve the soil flap lifting.

In the embodiments discussed, the blade 11 largely comprises part of a plate: the upper and lower surface of the blade 11 are substantially parallel.

In FIG. 22, an example of a formed soil wedge at soil wedge region 24 that forms during use can be seen, as explained above. When the soil-opener 3 is moved in the soil, the soil wedge region 24 becomes self-loaded with soil that collects en gets pressed together against the ridge 27 and the upper surface of the blade 11. The wedge that in use lifts the soil flap 16 can also be a combination of a soil wedge and the physical shape of the soil-opener 3 at the wedge region 24. Alternatively, a solid wedge can be provided in the shape shown in FIG. 22 for the soil wedge. The wedge (soil or solid) at the position of the blade 11 broadens (i.e., normal to plate 11) when going from the blade cutting edge 21. In an embodiment, it has a widest part after (i.e., when going from cutting edge 21 towards rear end) after the widest part 23 of blade 11.

In a direction normal to the blade surface, the wedge also decreases in width. Thus, in an embodiment in fact a wedge in two directions is formed.

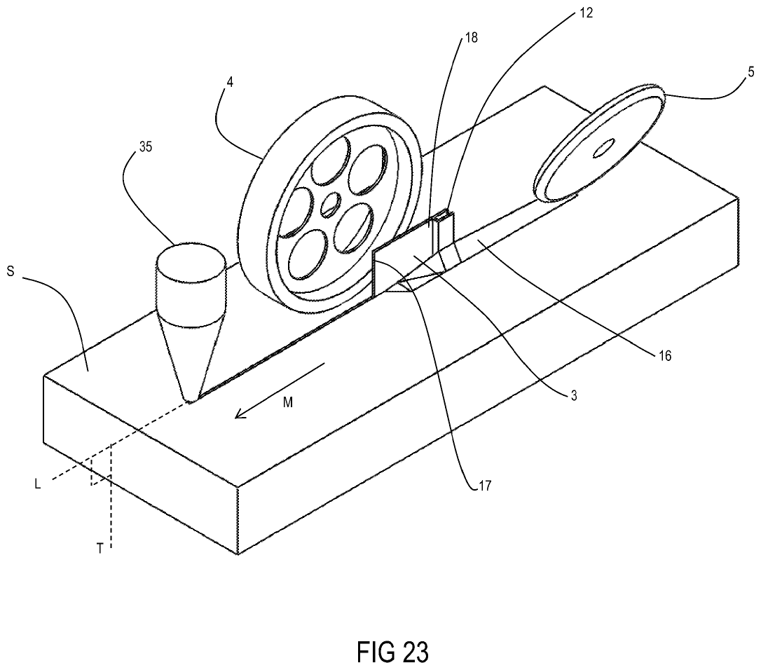

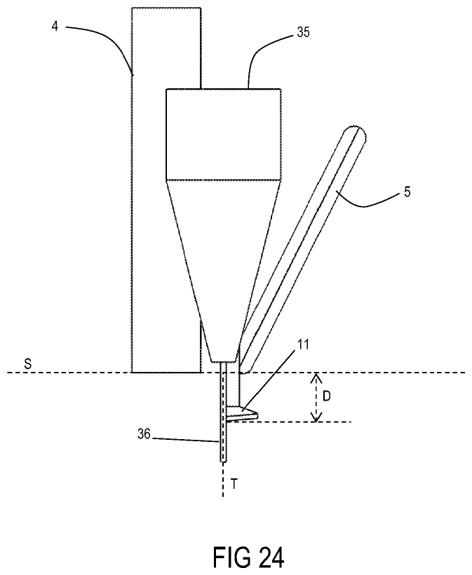

In FIGS. 23 and 24 an alternative embodiment of FIGS. 5 and 6 is shown, with a water cutter 35 instead of a mechanical cutter 2, in FIG. 23 perspective view and in FIG. 24 the embodiment of FIG. 23 in front view. Using the water cutter 35 producing in operation a cutting water beam 36 allows a better control over cutting depth, and provides a cleaner cut, thus reducing soil disturbance even further. The water cutter 35 can make a cut closed to, and better in line with, the leading edge 17 of the soil-opener. In FIGS. 23 and 24, the soil-opener 3 has a blade 11 extending to one side of the vertical cut.

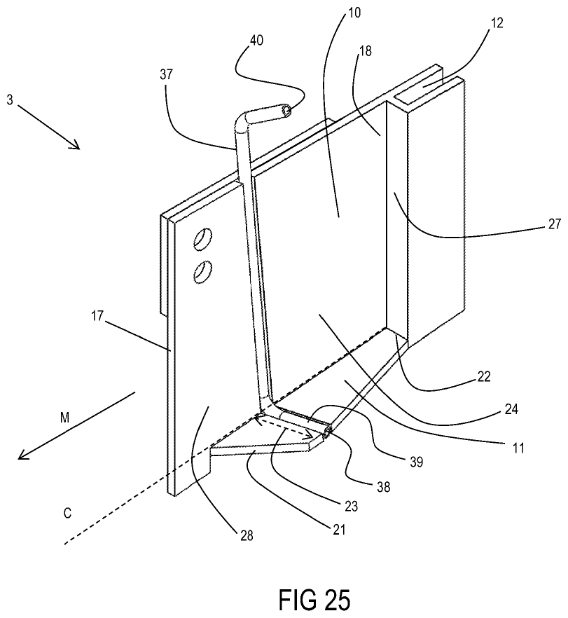

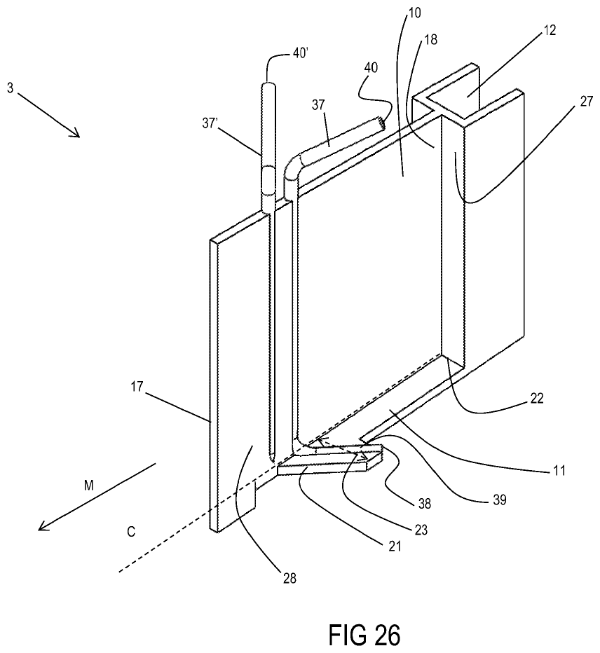

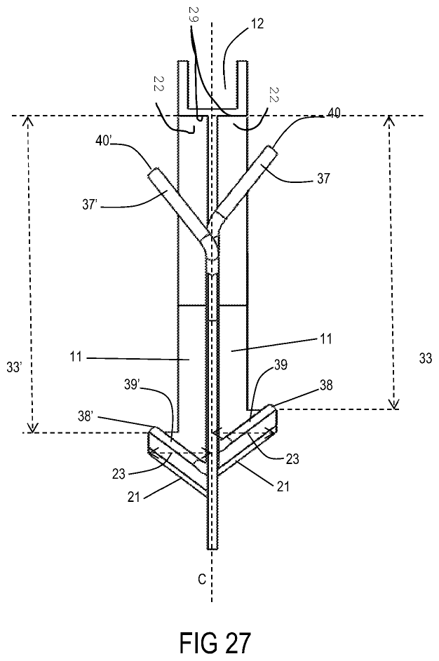

In FIGS. 25-27 embodiments of a soil-opener 3 with an incorporated conduit 37 or soil-opener conduit 37 for for instance a liquid component like liquid fertilizer is shown, integrated into an embodiment of a current soil-opener 3. In the depicted embodiments, the plate element 10 has been cut, displaced in-plane with respect to one another, and the conduit 37 or conduits has/have been included. Plate parts were then attached to one another again. FIG. 25 shows this. The conduit 37, 37′ has an inlet 40, 40′ for product. The conduit 37, 37′ have a conduit blade end 39, 39′ that runs through a blade 11. The conduit or line has an outlet 38, 38′. Here a space for fitting the conduit or line blade end 39, 39′ was machined out. Alternatively, for instance, a hole forming the conduit blade end 38, 38′ may be drilled. In the embodiments shown, the conduit 37, 37′ has an outlet 38, 38′ behind, rear of, the widest part 23 of the blade 11. The conduit 37, 37′ can have the outlet 38, 38′ directed sideward, shown in FIG. 25, or it may be directed or angled at an angle with respect to a backward direction, as shown for instance in FIG. 26. The conduit 37, 37′ allows deposition of liquid material for instance at a distance from the material deposited via the channel forming part 12. The outside diameter of the conduit 37, 37′ is in the range of 4-10 mm. In FIG. 26, for instance, the diameter is about 6 mm. In FIG. 27, there are two conduits 37 and 37′. This allows independent provision of product. When one of the conduits 37, 37′ gets blocked, it is easier to find and solve the problem.

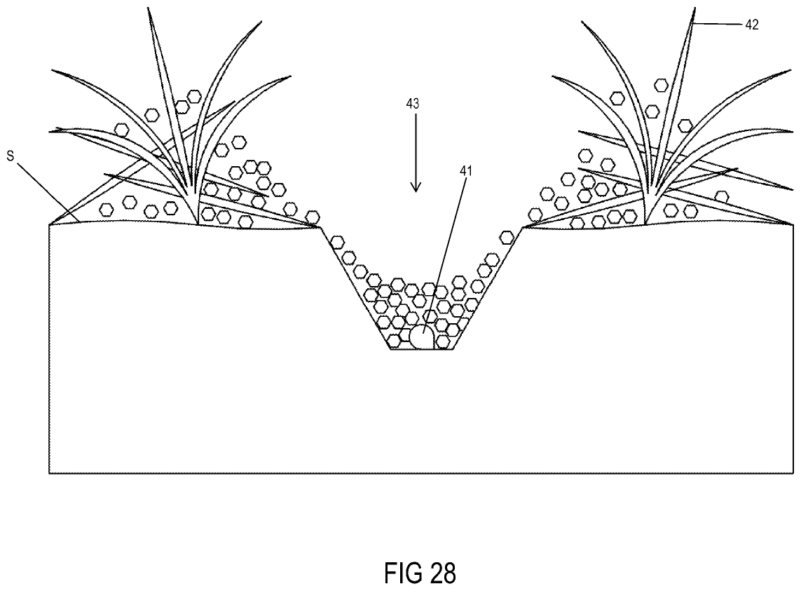

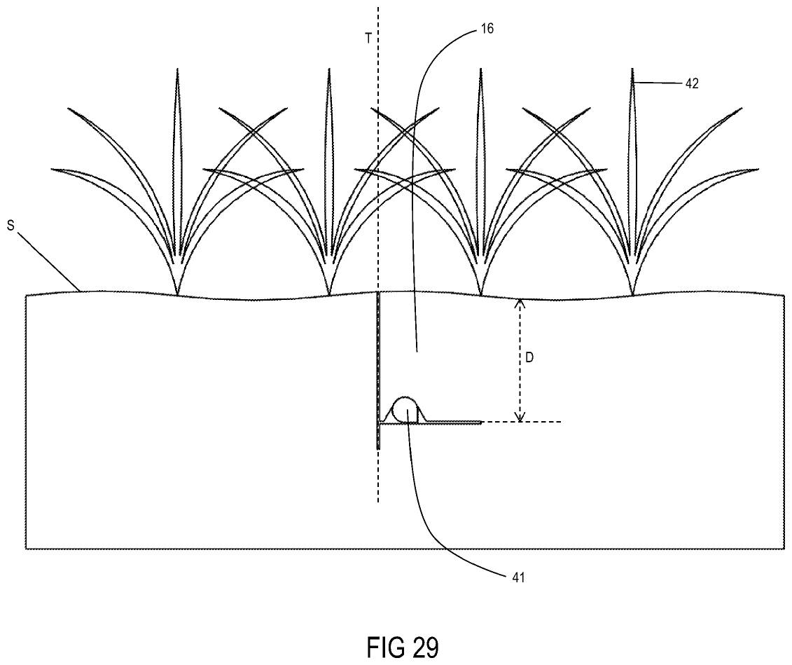

In FIG. 28 a cross section, perpendicular to the cuts made by a prior art root boot, of soil treated with a prior art root booth is shown. In contrast in FIG. 29 a cross section, perpendicular to the cuts made by a current soil-opener, of soil treated with the current soil-openers. Part of existing plant ends and roots 42 are removed, and soil gets disturbed and deposited sideward of a furrow 43. Material 41 is deposited into the furrow 43 and covered with disturbed soil.

In the state of the art, the root boot causes disturbance of the soil. In these embodiments, placement of seed 41 and additional components at a defined position and covering these with soil is of importance. It was found that placement of components 41 and drying of the soil were a problem when using prior art soil-openers. In the current soil-opener, disturbance of the soil is reduced to a minimum. Here, a small cut, or in fact almost a vertical incision along line T is made, and the soil-opener produces a horizontal cut or in fact more an incision along the dotted line is made. Material 41 is deposited below a soil flap 16. It was found that this approach causes a better plant development with reduced drying of the soil after treatment. Furthermore, seeds are less prone to be eaten by animals or insects, for instance.

It will also be clear that the above description and drawings are included to illustrate some embodiments of the invention, and not to limit the scope of protection. Starting from this disclosure, many more embodiments will be evident to a skilled person. These embodiments are within the scope of protection and the essence of this invention and are obvious combinations of prior art techniques and the disclosure of this patent.

### LIST OF REFERENCE NUMBERS

1 Soil-opening system
2 soil cutter
3 soil-opener
4 depth-setter
5 soil-closer
6 frame
7 soil cutter setting
8 soil-closer frame
9 product line
10 plate element
11 blade
12 channel-forming part
13 depth setting actuator
14 soil-closer setting
15 soil-opener coupler
16 soil flap
17 plate element leading edge
18 plate element trailing end
19 product flow
20 product dispenser
21 blade front cutting edge
22 blade rear end
23 blade widest part/widest blade width
24 soil wedge region
25 soil channel
26 soil bending region
27 plate element bunt end
28 plate element lower end
29 product line sideward bend
30 rear-facing strip surface
31 soil-opener attachment part
32 blade rear end width
33 distance between widest part and rear end of blade
34 vertical cut following part leading edge width
35 water cutter
36 water beam
37 soil-opener conduit
38 conduit outlet
39 conduit blade end
40 conduit inlet
M soil-opening system motion direction
D horizontal cut depth
S soil surface
α blade attack angle
R1 soil closer setting rotational axis
R2 soil closer frame rotational axis
R3 soil closer setting rotational axis
L vertical cut longitudinal direction
T vertical cut transverse direction
C blade centre line
W channel width

1. A soil-opener for in operation providing a functionally horizontal cut at a depth from a soil surface in a functionally vertical cut into soil for providing a soil flap for introducing a product into said soil, said soil-opener comprising:
a blade having a front cutting edge for in operation cutting said functionally horizontal cut, a rear end, a blade width, and said blade arranged for cutting soil functionally cross with respect to a said functionally vertical cut;
a channel forming part coupled to said blade, said channel forming part adapted for providing a channel allowing a said product to be introduced near said horizontal cut;
a soil flap lifting part adapted for lifting said soil flap, said soil flap lifting part coupled to said blade, and provided between said front cutting edge of said blade and said channel forming part;
a vertical cut following part adapted for allowing said soil-opener in operation to follow said functionally vertical cut, said vertical cut following part coupled to said blade and extending at least to said front cutting edge and opposite said rear end,
wherein said blade between said front cutting edge and said rear end has a widest part, said widest part is forward of the rear end of the blade, forward of said channel forming part near said rear end of the blade, at a front half of said blade, wider than said channel forming part near said rear end of the blade,
wherein said channel forming part ends near said rear end of said blade,
wherein a channel distance is 2-7 times a channel width, wherein said channel width is defined as a width of said channel forming part near said rear end of said blade and said channel width is parallel to a line through said widest part of said blade and wherein said channel distance is defined as a distance between said widest part of said blade and said channel forming part near said rear end and said channel distance is determined normal with respect to said blade width, and
wherein said blade width at said widest part of said blade is 1.2-5 times said channel width.

2. The soil-opener according to claim 1, wherein said width of said widest part of said blade is 1.5-4 times said channel width.

3.-5. (canceled)

6. The soil-opener according to claim 1, wherein said blade when going from the widest part to its rear end has a width that is at least the width at said rear end.

7. The soil-opener according to claim 1, wherein said blade width at its widest part is between 1.2 to 5 times a width of said blade at said rear end.

8. (canceled)

9. (canceled)

10. The soil-opener according to claim 1, wherein said blade width at said widest part is at least 5 cm, and said widest part of the blade is at least 5 cm in front of said rear end.

11. (canceled)

12. The soil-opener according to claim 1, wherein said blade has a blade length and a front quarter including said cutting edge, and has its widest part at said front quarter of said blade.

13. The soil-opener according to claim 1, further comprising a support element attaching said blade, said channel forming part, said soil flap lifting part, and said vertical cut following part together.

14. The soil-opener according to claim 1, wherein said soil flap lifting part comprises a wedge extending from said channel forming part and from a surface of said blade directed to said soil flap, and wherein said wedge is at least partially formed by a soil wedge formed by soil which in use gets collected on said blade surface and a ridge functionally perpendicular to said blade surface and extending substantially at said rear end of said blade.

15. (canceled)

16. The soil-opener according to claim 1, wherein said cut-following part has a leading edge for in operation extending into said functionally vertical cut, wherein said leading edge is straight and extends functionally perpendicular to said blade.

17. The soil-opener according to claim 1, wherein said channel forming part has a width extending from near said rear end of said blade toward a top of said soil-opener, wherein said width of said channel forming part is at least a width of said blade at said rear end, and wherein said channel forming part extending opposite at a distance from said cut-following part and extending in a longitudinal direction substantially parallel to said leading edge for providing a channel in a said vertical cut substantially down to said horizontal cut.

18. The soil-opener according to claim 13, wherein said support element comprises a plate element having a leading edge providing a said vertical cut following part, a trailing edge opposite said leading edge connected to said channel-forming part, and an adjacent lower side holding said blade.

19. The soil-opener of claim 18, wherein said blade is attached to said plate element, said blade extending at least near said lower side and along said lower side and arranged for cutting soil functionally cross with respect to said plate element.

20. The soil-opener according to claim 1, further comprising a conduit having an outlet at or near said widest part of said blade.

21. The soil-opener according to claim 1, wherein said blade extends in both sides of said vertical cut following part for providing horizontal cuts in both opposite soil walls of said functionally vertical cut.

22. The soil-opener according to claim 21, wherein said channel forming part extends at both sides of said vertical cut following part.

23. The soil-opener according to claim 1, wherein said channel forming part comprises at least two product lines for introducing product into said channel, one product line extending into said channel and comprising a sideward bent arranged for introducing said product underneath a soil channel near a bent of said soil flap.

24. The soil-opener according to claim 1, wherein said blade has a blade thickness of 3-6 mm, or a blade length of 10-20 cm.

25. The soil-opener according to claim 1, wherein said vertical cut following part has a vertical cut following part thickness of 5-9 mm.

26. (canceled)

27. A soil-opening system comprising the soil-opener according to claim 1, further comprising:
a soil-cutter for in operation providing a functionally vertical cut into a soil;
said soil-opener coupled to said soil-cutter, with its leading edge towards said soil-cutter and in line with said soil-cutter, and
a depth-setter coupled to said soil-opener for maintaining a set cutting depth of said blade.

28. (canceled)

29. The soil-opening system of claim 27, wherein said soil-cutter comprises a water cutter, said soil cutter positioned on said soil-opening system for in operation providing a vertical cut parallel and in line with said soil-opener leading edge, in particular said water cutter provided for in use providing a cutting water beam at 0.5-7 cm in front of said leading edge.

30. The soil-opening system of claim 27, wherein said vertical cut following part has substantially the same width as the cutting device placed in front of it.

31. A method for depositing a product into a soil using the soil-opener according to claim 1, comprising cutting a functionally vertical cut into soil, directing said soil-opener into said functionally vertical cut with its blade cutting functionally cross with respect to said vertical cut for providing a soil flap, advancing said soil-opener in said cut behind said soil-cutter, resulting in a lifting of said soil flap and producing a channel behind said soil-opener and extending at said lifted soil flap, depositing product into said channel, and allowing said soil flap to close.

32. The method of claim 31, wherein a further product is deposited into said channel, wherein said further product is deposited at a distance from said product, in particular said one of said products is deposited at said vertical cut near said cut from said blade, and the other of said products in said cut from blade away from said vertical cut, below said soil flap.
